(19) United States
(12) Patent Application Publication
(10) Pub. No.: US 2023/0335703 A1
(43) Pub. Date: Oct. 19, 2023

(54) SYSTEM FOR MANUFACTURING BI-CELL OF ALL-SOLID-STATE BATTERY

(71) Applicants: HYUNDAI MOTOR COMPANY, Seoul (KR); KIA CORPORATION, Seoul (KR)

(72) Inventor: Dae Won Lee, Suwon-si (KR)

(21) Appl. No.: 17/989,437

(22) Filed: Nov. 17, 2022

(30) Foreign Application Priority Data
Apr. 19, 2022 (KR) 10-2022-0048191

(51) Int. Cl. H01M 4/04

(52) U.S. Cl. CPC H01M 4/0435

(57) ABSTRACT

A bi-cell of an all-solid-state battery includes a positive electrode, a negative electrode bonded to the positive electrode, and a compensation member disposed to surround a perimeter of the positive electrode and attached to the negative electrode.

### CROSS REFERENCE TO RELATED APPLICATIONS

This application claims under 35 U.S.C. § 119(a) the benefit of priority to Korean Patent Application No. 10-2022-0048191, filed on Apr. 19, 2022, the entire contents of which are incorporated herein by reference.

### BACKGROUND

### (a) Technical Field

The present disclosure relates to an all-solid-state battery, and more particularly, to the manufacture of a bi-cell of an all-solid-state battery.

### (b) Background Art

A secondary battery is a rechargeable energy storage device. In most secondary batteries, cells are manufactured based on an organic solvent which is a liquid electrolyte, and thus, there are limits to improvement in stability and energy density. Therefore, development of all-solid-state batteries using a solid electrolyte is being carried out.

An all-solid-state battery uses a solid electrolyte instead of a liquid electrolyte and requires formation of interfaces having high quality between a negative electrode, the electrolyte and a positive electrode in order to secure performance, such as energy density. For this purpose, a manufacturing method using a high-pressure press configured to densely press an electrode material and the electrolyte against each other is being developed. However, such a high-pressure press method may cause damage to or breakage of a workpiece.

Therefore, prior to feeding of the all-solid-state battery into the high-pressure press, prepared is a bi-cell for securing interfaces between the negative electrode, the electrolyte, and the positive electrode by stacking thin sheets of the negative electrode, the electrolyte, the positive electrode, and the like. Here, there may be a size difference between the negative electrode and the positive electrode depending on product design, and such a size difference may cause damage to a final product.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a system for manufacturing a bi-cell of an all-solid-state battery which may prevent damage to an electrode incurred during a pressing process.

It is another object of the present disclosure to provide a system for manufacturing a bi-cell of an all-solid-state battery which has improved productivity.

In one aspect, the present disclosure provides a bi-cell of an all-solid-state battery, the bi-cell including a positive electrode, a negative electrode bonded to the positive electrode, and a compensation member disposed to surround a perimeter of the positive electrode, and attached to the negative electrode.

In another aspect, the present disclosure provides a method for manufacturing a bi-cell of an all-solid-state battery, the method including supplying a continuous sheet of negative electrode configured such that a plurality of negative electrodes is continuously formed, and attaching a continuous sheet of compensation member to the continuous negative electrode sheet, wherein the continuous sheet of compensation member is configured such that a plurality of compensation members is continuously formed

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view of a bi-cell according to one embodiment of the present disclosure;

FIG. 2 is an exploded perspective view of FIG. 1;

FIG. 3 is a cross-sectional view of FIG. 1 taken along line A-A′;

FIG. 4 is a perspective view of a stack cell acquired by stacking a plurality of bi-cells of FIG. 1;

FIG. 5A is a front view of a compensation member according to one embodiment of the present disclosure;

FIG. 5B is a side view of the compensation member according to one embodiment of the present disclosure;

FIG. 6 is a front view of a continuous sheet of compensation member according to one embodiment of the present disclosure;

FIG. 7 is a front view showing the state in which the continuous sheet of compensation member according to one embodiment of the present disclosure is adhered to a continuous sheet of negative electrode;

FIG. 8 is a front view showing a continuous sheet of compensation member having extension parts according to another embodiment of the present disclosure;

FIG. 9 is a view showing an auxiliary element for the continuous sheet of compensation member according to one embodiment of the present disclosure;

FIG. 10 is a cross-sectional view of the compensation member according to one embodiment of the present disclosure;

FIG. 11 shows a process of manufacturing a bi-cell including the compensation member according to one embodiment of the present disclosure;

FIG. 12 is a schematic view showing a system for manufacturing a bi-cell according to one embodiment of the present disclosure; and

FIG. 13 is a view showing the system according to one embodiment of the present disclosure in more detail.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows will be exemplarily given to describe the embodiments of the present disclosure, and the present disclosure may be embodied in many alternative forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

As described above, there may be a size difference between a negative electrode and a positive electrode which are stacked when an all-solid-state battery is manufactured. Here, members for compensating for the size difference between the negative electrode and the positive electrode may be used, but the members are adhered sheet by sheet, so productivity is low.

Therefore, the present disclosure provides a compensation member which may compensate for a size difference between a negative electrode and a positive electrode of an all-solid-state battery.

Further, the present disclosure suggests a method for manufacturing a bi-cell of an all-solid-state battery in which compensation members are continuously adhered to negative electrodes and positive electrodes to facilitate continuous production of bi-cells.

Hereinafter, exemplary embodiments of the present disclosure will be described in detail with reference to the accompanying drawings.

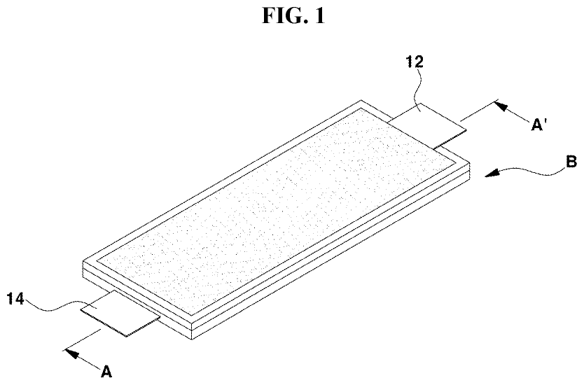

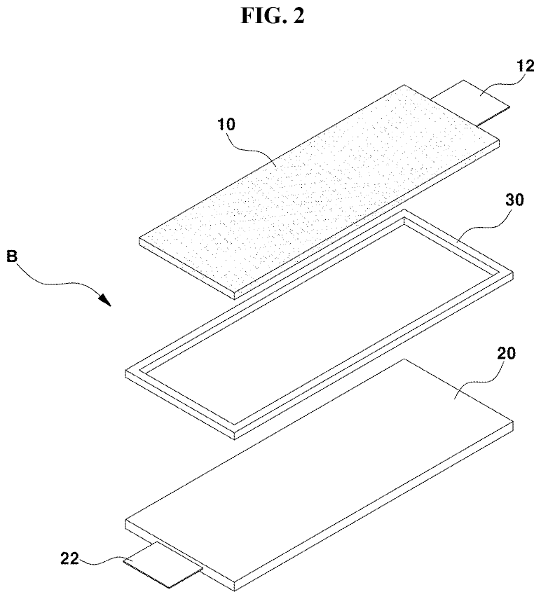

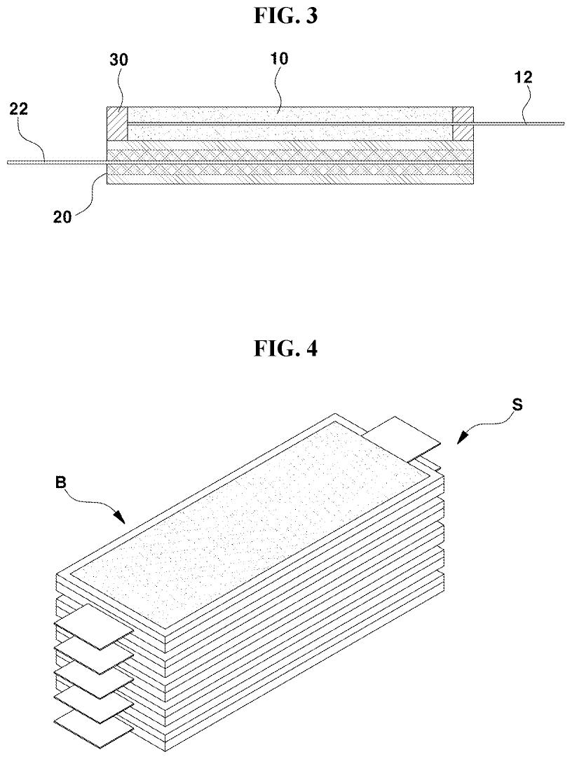

As shown in FIGS. 1 to 3, a bi-cell B includes a positive electrode 10, a negative electrode 20 and a compensation member 30. The positive electrode 10 and the negative electrode 20 are stacked, and a solid electrolyte is interposed between the positive electrode 10 and the negative electrode 20. Further, a solid electrolyte may also be formed on the other surface of the negative electrode 20. The compensation member 30 is disposed to come into contact with both the positive electrode 10 and the negative electrode 20. In an embodiment, a positive electrode terminal 12 of the positive electrode 10 and a negative electrode terminal 22 of the negative electrode 20 may be located on opposite sides of the bi-cell B.

A stack cell S shown in FIG. 4 is acquired by stacking a plurality of bi-cells B. Here, the compensation members 30 of the bi-cells B may function to be complementary to the compensation members 30 of the neighboring bi-cells B.

According to the present disclosure, the compensation member 30 may form an insulating layer and prevent damage from being incurred during a pressing process. Concretely, the compensation member 30 may prevent damage, such as dielectric breakdown, from being incurred due to a size difference between the positive electrode 10 and the negative electrode 20 during the pressing process when an all-solid-battery is manufactured. As one non-limiting example, the compensation member 30 may be an insulating tape.

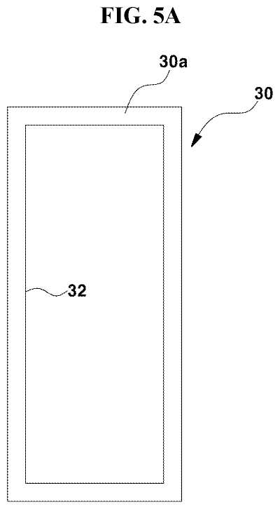

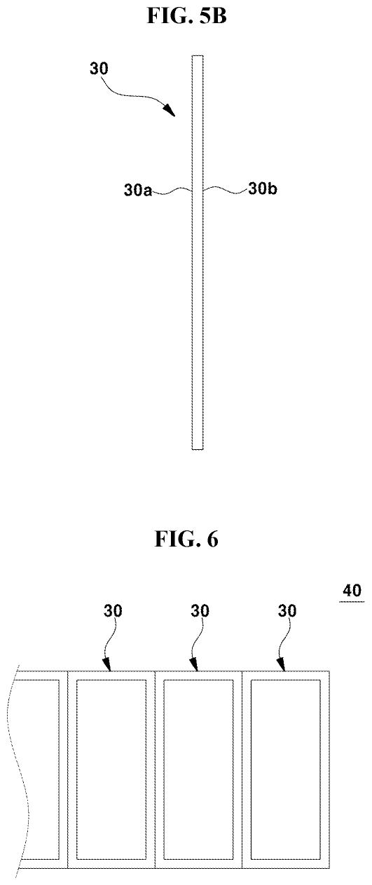

Referring to FIGS. 5A and 5B, the compensation member 30 may be provided in the form of a frame. Although these figures illustrate a rectangular frame shape, the shape of the compensation member 30 is not limited thereto, and may be changed depending on the shape of the positive electrode 10 and the negative electrode 20. In one example of implementation, the positive electrode 10 is disposed within the inner perimeter of the compensation member 30. The negative electrode 20 is disposed to approximately coincide with the outer perimeter of the compensation member 30. The inner perimeter of the compensation member 30 is at least equal to or greater than the perimeter of the positive electrode 10 to insert the positive electrode 10 into the compensation member 30, and is less than the perimeter of the negative electrode 20. Further, the outer perimeter of the compensation member 30 is at least equal to or greater than the perimeter of the negative electrode 20. After the compensation member 30 is adhered to the negative electrode 20, the compensation member 30 and the negative electrode 20 are simultaneously processed, and thereby, the compensation member 30 may be provided to have the same size and shape as the negative electrode 20.

The compensation member 30 includes a first surface 30a and a second surface 30b. For example, the positive electrode 10 is inserted into the compensation member 30 through the first surface 30a, and the negative electrode 20 is adhered to the second surface 30b of the compensation member 30. That is, the positive electrode 10 may come into contact with an inner perimeter surface 32 of the compensation member 30 through the first surface 30a, and the negative electrode 20 may be adhered to the second surface 30b of the compensation member 30. Further, the reverse is also possible. That is, although the terms first surface 30a and second surface 30b are used for the sake of clarity of explanation, the first surface 30a and the second surface 30b refer to one surface and the other surface of the compensation member 30. Hereinafter, it will be described that the negative electrode 20 is adhered to the second surface 30b for the sake of consistency in the description of the present disclosure.

An adhesive may be applied in advance to the first surface 30a to fix the bi-cells B in the stack cell S. Particularly, the adhesive applied to the first surface 30a may be an adhesive which is activated by heat. That is, the heat activated adhesive may be a material which has no adhesiveness at room temperature but has adhesiveness as temperature rises due to heating. Further, an adhesive may be applied in advance to the second surface 30b to fix the negative electrode 20. The adhesive applied to the second surface 30b may be a material which has adhesiveness at room temperature.

In one example of implementation of the present disclosure, after the compensation member 30 is adhered to the negative electrode 20, the positive electrode 10 may be mounted within the inner perimeter of the compensation member 30.

According to the present disclosure, a plurality of positive electrodes 10 and a plurality of negative electrodes 20 are continuously formed, respectively. As one non-limiting example, the plurality of positive electrodes 10 and the plurality of negative electrodes 20, which are continuously formed, may be provided in the form of a roll. Further, as shown in FIG. 6, a continuous sheet of compensation member 40, in which a plurality of compensation members 30 is continuously formed, is provided. As one non-limiting example, the continuous sheet of compensation member 40 may be provided in the form of a roll.

As shown in FIG. 5A, when the individual compensation members 30 are provided separately, there is a limit to productivity. Since the individual compensation members 30 should be adhered to the positive electrodes 10 and the negative electrodes 20 sheet by sheet, productivity is reduced. Therefore, in the present disclosure, the positive electrodes 10, the negative electrodes 20 and the compensation members 30 are continuously formed into a roll, respectively, so that the roll-to-roll method may be applied, and thereby, productivity may be greatly improved.

However, when tension is applied to the continuous sheet of compensation member 40 as the continuous sheet of compensation member 40 is transferred in roll equipment, deformation or meandering of the continuous sheet of compensation member 40 may occur due to shape imbalance. When the compensation member 30 is deformed, adhesion of the compensation member 30 to the negative electrode 20 may cause a defective product.

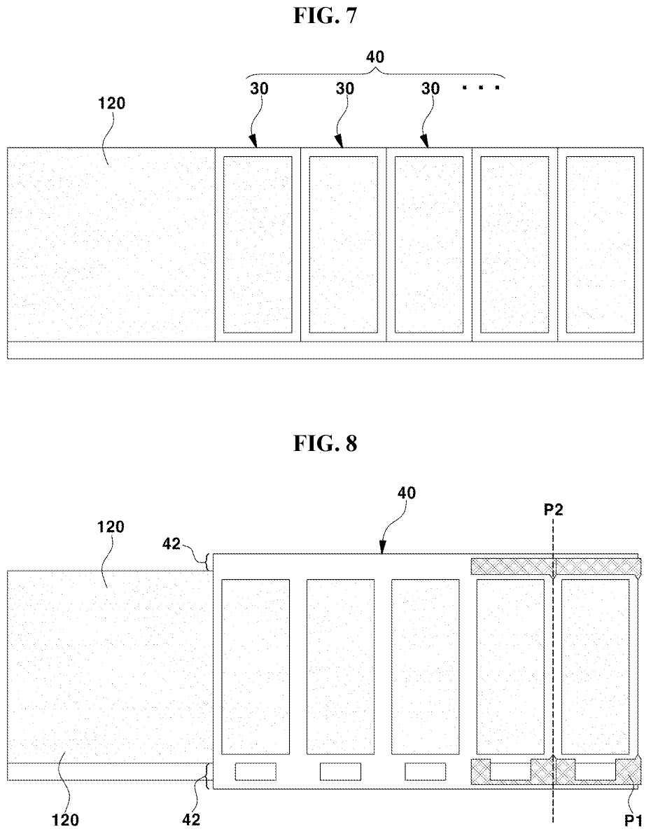

In order to sequentially stack the negative electrode 20, the compensation member 30 and the positive electrode 10, as shown in FIG. 7, the continuous sheet of compensation member 40 provided in the form of a roll and continuously supplied is first adhered to a continuous sheet of negative electrodes 120 in which the negative electrodes 20 are continuously formed into a roll.

Subsequently, an acquired negative electrode and compensation member assembly undergoes punching at a punching position P1 and cutting at a cutting position P2, and a continuous positive electrode sheet may be additionally adhered to the negative electrode and compensation member assembly, thereby manufacturing bi-cells B.

As described above, the compensation members 30 provided in the form of a frame are configured to have a sufficient rigidity to prevent deformation and breakage of the compensation members 30 during transfer in roll-to-roll manufacturing. In one example implementation of the present disclosure, extension parts 42 are provided on the continuous sheet of compensation member 40 (with reference to FIG. 8). The extension parts 42 may assist shape maintenance of the continuous sheet of compensation member 40 and provide additional rigidity to points where punching and cutting are performed during roll-to-roll transfer.

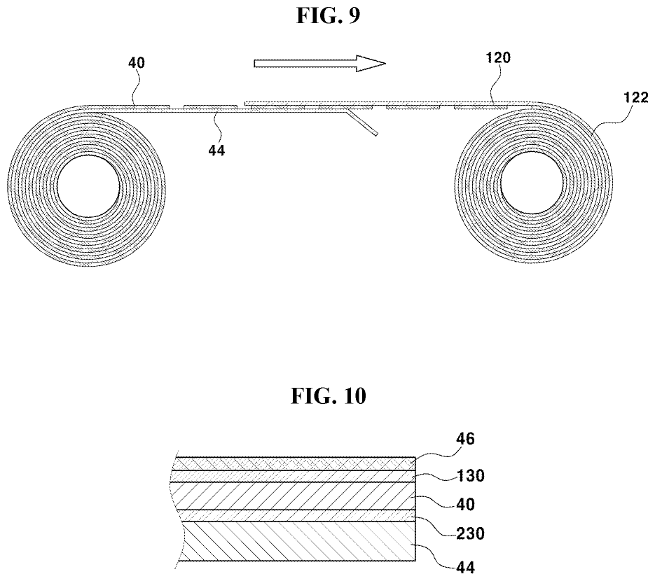

Referring to FIG. 9, in one example of implementation of the present disclosure, the continuous sheet of compensation member 40 may include an auxiliary element 44. As one non-limiting example, the auxiliary element 44 may be formed of polyethylene terephthalate (PET). When the continuous sheet of compensation member 40 alone is transferred during roll-to-roll manufacturing, the continuous sheet of compensation member 40 may be deformed or meander due to imbalance of tension applied thereto. Therefore, the auxiliary element 44 together with the continuous sheet of compensation member 40 may be wound into a roll. The continuous sheet of compensation member 40 including the auxiliary element 44 may be supported by the auxiliary element 44 before the negative electrode 20 is adhered to the continuous sheet of compensation member 40, and may be supported by the negative electrode 20 after the negative electrode 20 is adhered to the compensation member 40. Therefore, during transfer in roll-to-roll manufacturing, the continuous sheet of compensation member 40 is always supported by the auxiliary element 44 or the electrodes 10 and 20. Accordingly, there is no section in which the compensation members 30 alone are transferred, and thus, problems, such as deformation of and damage to the compensation members 30 due to transfer, may be solved.

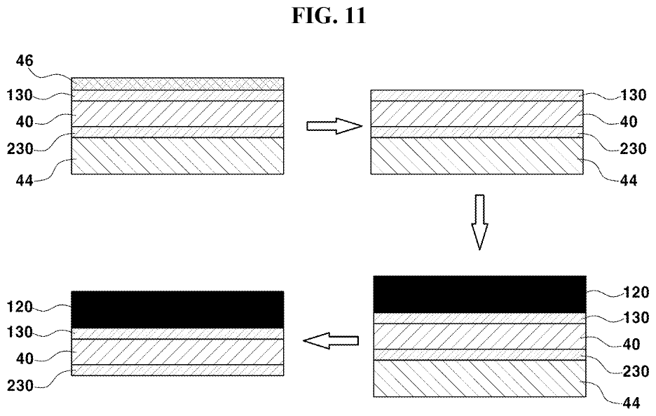

Referring to FIG. 10, in one example of implementation, the continuous sheet of compensation member 40 or the individual compensation members 30 may further include a protective element 46. The protective element 46 may be located to protect a part of the compensation member 30 to which the adhesive is applied. Particularly, the protective element 46 may be disposed on the second surface 30b of the compensation member 30 (i.e., the surface of the compensation member 30 to which the negative electrode 20 is adhered). Concretely, a second adhesive layer 230 is formed on the first surface 30a of the compensation member 30 by applying the heat activated adhesive, and the auxiliary element 44 is adhered to the second adhesive layer 230. The protective element 46 may be disposed on a first adhesive layer 130 formed on the second surface 30b of the compensation member 30 to protect the first adhesive layer 130. Therefore, the protective element 46 may protect the first adhesive layer 130 before an electrode, i.e., the negative electrode 20, is adhered thereto. As described above, the second adhesive layer 230 is provided to increase fixing force between neighboring bi-cells B in the stack cell S.

As shown in FIG. 11, there is no section in which the individual compensation members 30 alone are transferred during the roll-to-roll process. As shown in the first schematic of FIG. 11, the continuous sheet of compensation member 40 including a plurality of layers, i.e., the compensation members 30, the first adhesive layer 130, the second adhesive layer 230, the auxiliary element 44 and the protective element 46, is fed. Further, as shown in the second schematic of FIG. 11, the protective element 36 is removed before the negative electrodes 20 are adhered to the continuous sheet of compensation member 40. In these two sections, the compensation members 30 are supported by the auxiliary element 44. Further, as shown in the third schematic of FIG. 11, the negative electrodes 20 are adhered to the first adhesive layer 130. Here, the compensation member 30 is supported by two elements, i.e., the negative electrode 20 and the auxiliary element 44. As shown in the last schematic of FIG. 11, when the negative electrodes 20 are adhered to the first adhesive layer 130, the auxiliary element 44 is removed. As such, according to the present disclosure, there is no section in which the compensation elements 30 alone are transferred, and thus, deformation or meandering of the compensation elements 30 may be minimized, and may be more easily applied to the roll-to-roll process.

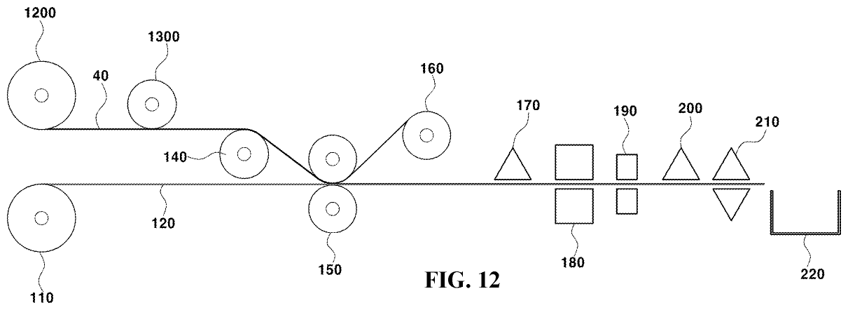

Referring to FIG. 12, an exemplary method for manufacturing the bi-cell B including the compensation member 30 will be described. Particularly, as described above, the bi-cell B may be manufactured by roll-to-roll processing.

The continuous sheet of negative electrode 120 including a plurality of negative electrodes 20 is unwound from a negative electrode unwinding unit 110 on which electrodes, i.e., the negative electrodes 20, are wound. Further, the continuous sheet of compensation member 40 is unwound from a compensation member unwinding unit 1200 on which the continuous sheet of compensation member 40 is wound. As the continuous sheet of compensation member 40 passes through a roll cutter 1300, the shape of the continuous sheet of compensation member 40 is processed. Subsequently, the continuous sheet of compensation member 40 is fed into a combination unit 150 while the protective element 46 is removed from the continuous sheet of compensation member 40 by a protective element winding unit 140. The protective element 46 removed from the continuous sheet of compensation member 40 is wound on the protective element winding unit 140. Further, the continuous sheet of compensation member 40 meets the continuous sheet of negative electrode 120 and is adhered to the negative electrodes 20 in the combination unit 150. While the continuous sheet of compensation member 40 is adhered to the continuous sheet of negative electrode 120 in the combination unit 150, the auxiliary element 144 adhered to the second adhesive layer 230 is removed from the compensation members 30 and wound on an auxiliary element winding unit 160. Thereby, adhesion of the continuous sheet of compensation member 40 to the continuous sheet of negative electrode 120 is completed. Further, the unwinding units 110 and 1200, the winding units 140 and 160, the roll cutter 130 and the combination unit 150 may be driven by a servomotor.

Thereafter, vision inspection, electrode processing, etc., may be executed. First, the continuous sheet of negative electrode 120 and the continuous sheet of compensation member 40 adhered to each other are inspected by a compensation member vision unit 170. Negative electrode terminals 22 are processed by a press 180 in consideration of the positions of the compensation members 30. The continuous sheet of negative electrode 120 and the continuous sheet of compensation member 40 adhered to each other are cut to a predetermined size by a cutter 190. After that, the sizes and surfaces of processed products are inspected by a size vision unit 200 and a surface vision unit 210. Then the processed products, which have passed these inspections, are loaded in a loading box.

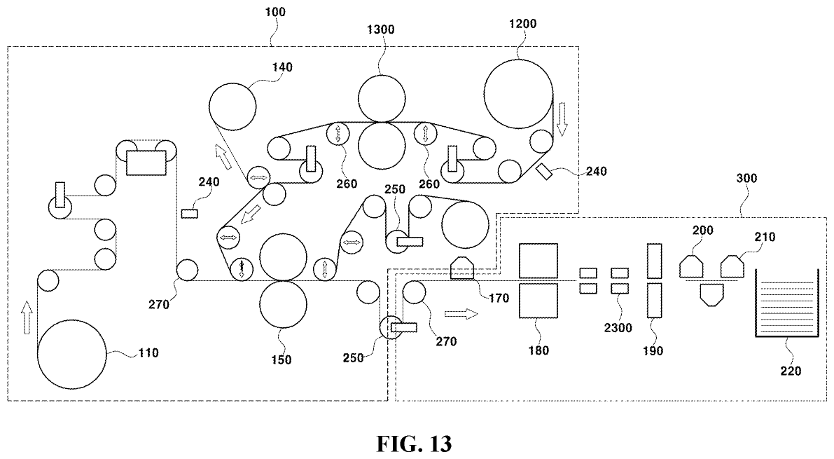

In an embodiment, a bi-cell manufacturing apparatus shown in FIG. 13 may be provided. The above description with reference to FIG. 12 may be applied, and thus, a detailed description of elements, which are the same as those in the above description, will be omitted.

During the process, the continuous sheet of compensation member 40 and the continuous sheet of negative electrode 120 are controlled at a designated tension and a designated speed in a continuous area 100. Precise transfer control may be applied to a transfer distance in an intermittent area 300. The reason for this is i) to coincide the positions of the compensation members 30, the processing positions of the negative electrode terminals 22, and the cutting positions of the negative electrodes 20 with each other, and ii) to inspect the positions of the compensation members 30, and the sizes and surface states of the negative electrodes 20, in the intermittent area 300.

In the intermittent area 300, a roll feeder, a grip feeder 2300, etc., may be additionally provided, which allows the negative electrodes 20 attached with the compensation members 30 to be better precisely transferred and creates a stop section in which the press 180, the cutter 190 and the vision units 200 and 210 perform their own functions.

Further, the bi-cell manufacturing apparatus may further include an edge position control (EPC) system 240. Meandering correction of the negative electrode 20 unwound from the negative electrode unwinding unit 110 and the compensation member 30 unwound from the compensation member unwinding unit 1200 through the EPC system 240 has been completed before the negative electrode 20 and the compensation member 30 reach the combination unit 150. As one non-limiting example, when meandering is controlled through the EPC system 240, a pivot-type or spool-type EPC system may be used.

The bi-cell manufacturing apparatus may further include one or more dancers 250 for tension control. Particularly, tension control may be executed through the dancers 25 before or after a cutting section. As one non-limiting example, the bi-cell manufacturing apparatus may further include a powder brake, a powder clutch, etc. In case of tension control through the dancers 250, fluctuations in tension control may be minimized using a low-friction cylinder. In case of tension control through the powder brake or the powder clutch, a load cell may be further provided to detect tension of a target object to be transferred during transfer, and to perform compensation control.

The bi-cell manufacturing apparatus may further include adjusting rolls 260. The adjusting rolls 260 may correct web angles of the roll cutter 1300, the upstream and downstream parts of the combination unit 150, a point where the protective element 46 is removed, a point where the auxiliary element 44 is removed, etc. Further, a plurality of rollers 270 may be provided to properly guide the transfer path of the negative electrodes 20 and the compensation members 30. In FIG. 13, although reference numerals are not stated, elements displayed in a circle accompanied by a rectangle indicate dancers 250, and elements displayed in a circle in which arrows are disposed indicate adjusting rolls 260.

Although the exemplary embodiments of the present disclosure describe that the compensation member 30 is first adhered to the negative electrode 20, the negative electrode 20 may be replaced with the positive electrode 10. Further, a description of the positive electrode 10 is omitted for avoidance of redundancy, but would be apparent to those skilled in the art.

According to the present disclosure, a size difference between a negative electrode and a positive electrode may be compensated for, and damage to an electrode incurred during a pressing process may be prevented.

Further, the present disclosure allows a compensation member to be applied to a roll-to-roll process, thereby being capable of continuously manufacturing bi-cells.

In addition, according to the present disclosure, elongation, deformation, etc. of the compensation member incurred during the roll-to-roll process may be minimized, and thus, quality and mass-productivity of bi-cells may be secured.

As is apparent from the above description, the present disclosure provides a system for manufacturing a bi-cell of an all-solid-state battery which may compensate for a size difference between a negative electrode and a positive electrode so as to prevent damage to an electrode incurred during a pressing process.

Further, the present disclosure provides a system for manufacturing a bi-cell of an all-solid-state battery which may be applied to a roll-to-roll process so as to have improved productivity.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A bi-cell of an all-solid-state battery, the bi-cell comprising:
a positive electrode;
a negative electrode bonded to the positive electrode; and
a compensation member surrounding a perimeter of the positive electrode and attached to the negative electrode.

2. The bi-cell of claim 1, wherein:
the compensation member comprises a first surface, a second surface opposite to the first surface, and an inner perimeter surface substantially perpendicular to the first surface and the second surface; and
the negative electrode is adhered to the first surface, and the positive electrode is inserted into the compensation member within the inner perimeter surface.

3. The bi-cell of claim 2, wherein a first adhesive layer for adhesion to the negative electrode is formed on the first surface, and a second adhesive layer for adhesion to a neighboring bi-cell is formed on the second surface.

4. The bi-cell of claim 3, wherein the second adhesive layer is formed of a heat activated adhesive.

5. A method for manufacturing a bi-cell of an all-solid-state battery, the method comprising:
supplying a continuous sheet of negative electrode configured such that a plurality of negative electrodes is continuously formed; and
adhering a continuous sheet of compensation member configured such that a plurality of compensation members is continuously formed, to the continuous sheet of negative electrode.

6. The method of claim 5, further comprising separating an assembly, acquired by adhering the continuous sheet of compensation member, to the continuous sheet of negative electrode, into individual negative electrodes.

7. The method of claim 6, wherein each of the compensation members is adhered to each of the individual negative electrodes.

8. The method of claim 5, wherein the continuous sheet of negative electrode and the continuous sheet of compensation member are manufactured by roll-to-roll processing.

9. The method of claim 6, wherein separating the assembly into the individual negative electrodes comprises processing the assembly.

10. The method of claim 9, wherein:
processing the assembly comprises cutting extension parts of the continuous sheet of compensation member, wherein the extension parts are provided at opposing ends of the compensation member and extend outward of the continuous sheet of negative electrode.

11. The method of claim 5, further comprising:
removing an auxiliary element from the continuous sheet of compensation member, during or after the adhering the continuous sheet of compensation member to the continuous sheet of negative electrode,
wherein the auxiliary element is adhered to one surface of the continuous sheet of compensation member opposite to a remaining surface of the continuous sheet of compensation member, and adhered to the continuous sheet of negative electrode.

12. The method of claim 5, further comprising:
removing a protective element from the continuous sheet of compensation member, before the adhering the continuous sheet of compensation member to the continuous sheet of negative electrode,
wherein the protective element is adhered to one surface of the continuous sheet of compensation member, and adhered to the continuous sheet of negative electrode.

13. The method of claim 5, wherein the continuous sheet of negative electrode and the continuous sheet of compensation member are each unwound from a roll to be bonded to each other.

14. The method of claim 11, wherein the removed auxiliary element is wound into a roll.

15. The method of claim 12, wherein the removed protective element is wound into a roll.

16. The method of claim 6, further comprising inspecting the assembly, acquired by adhering the continuous sheet of compensation member to the continuous sheet of negative electrode, and the separated negative electrodes by a vision unit.

17. The method of claim 6, wherein the supplying the continuous sheet of negative electrode and the adhering the compensation member to the continuous sheet of negative electrode are continuously performed.

18. The method of claim 16, wherein, in the inspecting the assembly and the separated negative electrodes, precise transfer control is performed.
